(19) United States
(12) Patent Application Publication
(10) Pub. No.: US 2015/0247551 A1
(43) Pub. Date: Sep. 3, 2015

(54) Torsional Vibration Damping Arrangement With Power Splitting

(71) Applicant: ZF FRIEDRICHSHAFEN AG, Friedrichshafen (DE)

(72) Inventors: Daniel Lorenz, Bad Kissingen (DE); Thomas Weigand, Schweinfurt (DE); Tobias Höche, Hofheim i.UFr. (DE)

(21) Appl. No.: 14/438,535

(22) PCT Filed: Sep. 23, 2013
(86) PCT No.: PCT/EP2013/069741

§ 371 Date: Apr. 24, 2015

(30) Foreign Application Priority Data
Oct. 24, 2012 (DE) 10 2012 219 421.5

(51) Int. Cl. F16F 15/131; F16D 3/12; F16F 15/134

(52) U.S. Cl. CPC F16F 15/13128; F16F 15/13469; F16F 15/13157; F16D 3/12; F16D 2300/06

(57) ABSTRACT

A torsional vibration damping arrangement for transmitting a rotation from an input side to an output side includes a first and second torque transmission path arranged between the input side and the output side. A coupling arrangement serves to superpose the first torque component and second torque component. A phase shifter arrangement serves to generate a phase shift between torsional vibrations which are transmitted to the coupling arrangement via the first and second torque transmission paths, wherein the phase shifter arrangement comprises an oscillatory system with a primary side coupled with the input side and a secondary side which is rotatable with respect to the primary side and which is connected to the coupling arrangement. An effective mass moment of inertia of the secondary side inhibiting a change in a rotational velocity of the secondary side is dependent upon the rotational velocity.

### PRIORITY CLAIM

This is a U.S. national stage of application No. PCT/EP2013/069741, filed on Sep. 23, 2013. Priority is claimed on the following application: Country: Germany, Application No.: 10 2012 219421.5, Filed: Oct. 24, 2012, the content of which is incorporated herein by reference in its entirety.

### FIELD OF THE INVENTION

The present invention relates to torsional vibration damping arrangements, particularly torsional vibration damping arrangements in which power splitting takes place.

### BACKGROUND OF THE INVENTION

In powertrains, particularly powertrains in vehicles operated by internal combustion engines, rotational irregularities often occur in the form of fluctuations in the torque delivered by the crankshaft or in the delivered speed. One of the reasons for this is that in internal combustion engines an input of energy resulting in a rotational movement, for example, through ignition of a fuel-air mixture, takes place only in discrete time intervals. Due to the time-discrete energy input, the torque delivered by the crankshaft and also the rotational speed of the crankshaft are subject to fluctuations or oscillations around a mean value. In the following, these fluctuations are generally understood to mean rotational irregularities which can lead to torsional vibrations in the powertrain, i.e., to oscillations in the rotational speed which are superposed on a rotation at constant speed.

Rotational irregularities of this kind may be noticeable during driving operation and should be eliminated or damped as far as possible. Numerous technologies are known for damping these rotational irregularities. For example, by employing force accumulators or energy accumulators a portion of the energy occurring in a rotational irregularity can be stored intermediately and subsequently delivered in the powertrain such that a smoothed speed curve or torque curve is achieved. Examples of systems of this type are dual mass flywheels and tuned mass dampers having a pendulum mass by which a deflection of a vibrating mass takes place against centrifugal force due to the rotational irregularity, and the vibrating mass accordingly oscillates parallel with and opposite to the direction of centrifugal force.

A newer approach consists in the use of power splitting systems in which the torque generated by the drive unit is transmitted in parallel via a first torque transmission path and a second torque transmission path. The two torque transmission paths run into a coupling arrangement which reunites the torques transmitted by the different torque transmission paths. A damping or elimination of torsional vibrations can be achieved through a phase shifter arrangement for generating a phase shift between torsional vibrations which are transmitted to the coupling arrangement via the first torque transmission path and torsional vibrations which are transmitted to the coupling arrangement via the second torque transmission path. Elimination is achieved in exceptional cases, for example, when the phase shift is 180° and the amplitudes of the two vibration components are in the correct ratio which depends on the coupling arrangement.

Because of ongoing efforts to improve energy efficiency in vehicles, powertrains are often designed which are driven by engines at low speed or reduced engine displacement (downspeeding and downsizing). The low speed range from idle speed to, e.g., 1400 rpm or 1800 rpm which is the subject of increasingly closer focus leads to increasing excitations of rotational irregularities. In addition, new sources of rotational irregularities are created, for example, by engines with cylinder cutout, start/stop systems and/or vehicles with different levels of hybridization. This in turn requires torsional vibration damping arrangements with power capability or capability of damping rotational irregularities which appreciably outstrip those in present-day systems, i.e., torsional vibration damping arrangements which allow an improved damping of torsional vibrations.

### SUMMARY OF THE INVENTION

The present invention make this possible in that, in a torsional vibration damping arrangement with power splitting for causing a phase shift between torsional vibrations which are transmitted via a first torque transmission path from an input side to an output side and torsional vibrations transmitted via a second torque transmission path, an oscillatory system with a secondary side having an effective mass moment of inertia dependent upon the rotational velocity is used for generating the phase shift. The oscillatory system which is used for generating a phase shift and which comprises a primary side coupled with the input side of the torsional vibration damping arrangement and a secondary side which is rotatable with respect to the primary side around an axis of rotation is constructed in such a way that an effective mass moment of inertia of the secondary side, i.e., the mass moment of inertia that inhibits a change in a rotational velocity of the secondary side, is dependent upon the rotational velocity.

In a conventional power splitting system, there is in principle exactly one speed at which the rotational irregularities through the summation of torques in the coupling arrangement in which the torques are summed in fixed proportion is carried out. For this reason, this speed is also referred to as cancellation point.

Through the use of an embodiment of the present torsional vibration damping arrangement, this cancellation point can in principle be expanded to an entire speed band in that the effective mass moment of inertia of the secondary side of the oscillatory system in the torsional vibration damping arrangement is changed in a speed-dependent manner. With suitable adaptation, by repositioning the effective mass moment of inertia, the amplitudes of the rotational irregularities which are transmitted via the torque transmission path containing the oscillatory system can be changed through the change in the effective mass moment of inertia of the secondary side of the oscillatory system depending on the speed such that they are compensated approximately completely in spite of the summation of torques in a constantly fixed ratio over the entire speed range through which the repositioning takes place.

Embodiments of the present invention can be utilized, for example, to operate a drive engine that is coupled with the torsional vibration damping arrangement according to an embodiment of the invention predominantly at low speeds without having to settle for perceptible disturbances in the powertrain of a vehicle or motor vehicle. Usually, rotational irregularities have a particularly noticeable effect in powertrains, but this can be prevented because a virtually complete compensation of rotational irregularities over the entire relevant speed range can be achieved by means of an embodiment of a torsional vibration damping arrangement.

In particular, according to some embodiments of the present invention, the effective mass moment of inertia of the secondary side becomes lower as the speed increases, so that the speed dependency of the rotational irregularities having amplitudes in scale with the speed of the engine, which speed dependency is typical for an internal combustion engine, is compensated.

As used herein, effective mass moment of inertia means that mass moment of inertia which actually opposes or inhibits a change in the angular velocity of the secondary side. As will be explained in the following, this can differ from a mass moment of inertia which, conventionally speaking, can only be calculated from the static distribution of mass of an object in space, particularly when some elements of the distribution of masses are movable relative to one another.

There are a number of possibilities according to the invention for implementing the speed-dependent change in this effective mass moment of inertia. According to some embodiments of the present invention, the secondary side comprises a central element and at least one mass element which is connected to the central element so as to be fixed with respect to rotation relative to it such that this connection is canceled when a predetermined rotational velocity is exceeded, wherein the non-rotational connection is produced again when the rotational velocity once again falls below the predetermined rotational velocity. By connecting and decoupling the mass element, the total mass of the system which is effectively rotated by an excitation increases or decreases, which results in an increase or decrease in the effective mass moment of inertia. This change in the effective mass moment of inertia can be inexpensively and efficiently implemented simply by connecting and disconnecting an additional mass.

According to some embodiments, the at least one mass element comprises an annular shape, or has an annular shape, which can rotate around the axis of symmetry of the ring relative to the central element, i.e., is movable in circumferential direction relative to the central element. Among other advantages in using annular masses is that they can be produced simply and precisely so that the risk of unbalances being introduced into the system by the additional mass element or mass elements is low.

According to some embodiments of the invention, the annular part or annular mass element has along the circumferential direction thereof a plurality of apertures which are adjacent to one another and which extend radially completely through the mass element and in which a locking pin of an actuating element can engage, this locking pin being in turn non-rotationally and radially movably connected to the central element. This makes it possible in a simple manner to undo the non-rotational connection of the mass element at higher speeds at which the actuating element moves from a radially inner position to a radially outer position under centrifugal force.

The locking pin of the actuating element, which locking pin extends through one of the apertures in the mass element in the radially inner position, is moved radially outward together with the actuating element as speed increases such that, after a predetermined limiting speed, the locking pin is moved out of the aperture and the non-rotational connection of the mass element to the central element or secondary side is canceled. Accordingly, a canceling of a connection of the mass element to the central element is caused at a predetermined speed efficiently, economically and in a long-term stable manner without actively controlled actuators or the like.

According to some further embodiments of the present invention, a plurality of annular mass elements with apertures extending radially through the mass elements is used, wherein the individual mass elements are arranged concentric to one another and radially adjacent to one another with increasing diameter. The individual mass elements are rotatable relative to one another, the apertures thereof having the same angular spacing such that in the radially inner position of the actuating element, the locking pin thereof extends through an aperture in each of the mass elements in each instance so as to connect all mass elements non-rotationally to the central element in the radially inner position. These embodiments allow a multi-step switching characteristic or a multi-step speed-dependent variation of the effective mass moment of inertia, which can result in that the cancellation point can be expanded over a greater speed range and that the rotational irregularities can be damped or compensated more efficiently within a greater speed range by means of this embodiment of the present invention.

According to some embodiments of the present invention, in order to optimize the switching characteristic of the embodiments having a plurality of mass elements, a sliding element formed of a material differing from the material of the mass elements is arranged between two radially adjacent mass elements in each instance in order to reduce the friction between the adjacent mass elements and to prevent mass elements whose coupling should actually be canceled from nevertheless contributing to the effective mass moment of inertia with reduced friction.

According to some embodiments of the present invention, the actuating element is movable radially outward under centrifugal force against the action of a spring element, which makes it possible to adjust the switching characteristic or speed adaptivity of the torsional vibration damping arrangement more precisely by using a suitable spring characteristic for the spring element such that individual mass elements can be uncoupled at exactly predefined speeds. To this end, particularly the spring elements of some embodiments have a progressive spring characteristic curve or have a spring characteristic curve having at least one, or more than one, abrupt change in spring stiffness.

According to some embodiments of the present invention, the actuating elements have at least one further locking pin which extends only through the apertures of a group of radially outer mass elements in the radially inner position of the actuating element, wherein the mass elements of this group have a recess extending in circumferential direction in the region of the locking pin or first locking pin. In other words, a first locking pin extends radially completely inward through the assembly of radially staggered mass ring elements, while a second locking pin does not extend completely inward but rather blocks, or non-rotationally connects, at least one radially outer mass ring. With the system being configured in the same way in other respects, this can have the advantage that more mass ring elements having a constant thickness can be uncoupled with the radial travel of the actuating element remaining the same so that, in turn, a radial installation space required for the actuating elements is reduced.

According to some embodiments of the present invention, the mass elements are arranged within a volume which is at least partially filled with a lubricant; that is, the apparatus is operated in a lubricated manner to assist an uncoupling between the mass element and the central element or between the individual mass elements so that these mass elements in uncoupled condition can no longer contribute in an unwanted manner to the effective mass inertia of the secondary side, for example, through friction torques or the like.

According to further embodiments of the invention, the speed-dependent varying of the effective mass inertia can be achieved in an economical and efficient manner in that a sole mass element is provided which is movable in circumferential direction relative to the central element, wherein the mass element is pressed by a spring arrangement in axial direction against a thrust surface at the central element. In other words, the contribution of the mass of the mass element to the effective mass moment of inertia is achieved via a frictional connection between the primary element and the mass element which is reinforced by the spring arrangement or whose strength can be adjusted through the spring arrangement. This can have the advantage that a dependency of the effective mass moment of inertia on the angular acceleration is established already at a constant spring force because, after a certain angular acceleration when the friction limit between the mass element and the central element is exceeded, a mass element which is then moved relative to the central element and which slides at the thrust surface no longer contributes to the effective mass moment of inertia with its entire inert mass.

According to some embodiments, the possibility of adapting this type of embodiment of the invention is additionally expanded in that the pressing force caused by the spring arrangement is dependent on the rotational velocity so that the rotational velocity proceeding from which a sliding is initiated between the mass element and the central element can be further influenced in addition to the dependency on the friction coefficients of the relevant materials. In other words, the pressing force is varied in a speed-adaptive manner.

### BRIEF DESCRIPTION OF THE DRAWINGS

Exemplary embodiments will now be described with reference to the accompanying drawings in which:

FIG. 1 is a partial sectional view of a prior art power splitting system for damping torsional vibrations;

FIG. 2 is a plan view of an intermediate mass or a secondary side of an oscillatory system according to an embodiment of a torsional vibration damping arrangement of the present invention;

FIG. 3A is a longitudinal sectional view through the embodiment of FIG. 2;

FIG. 3B is a cross sectional view through the embodiment of FIG. 2;

FIG. 4 is a longitudinal sectional view through the embodiment of FIG. 2 at increased speed;

FIG. 5 is a diagram showing a speed dependency of a mass moment of inertia of an intermediate mass or a secondary side of an oscillatory system according to an embodiment of the present invention;

FIG. 6 is a plan view of an intermediate mass or a secondary side of an oscillatory system according to a further embodiment of a torsional vibration damping arrangement of the present invention;

FIG. 7A is a cross sectional view through the embodiment of FIG. 6;

FIG. 7B is a longitudinal sectional view of FIG. 7A along the line C-C;

FIG. 7C is a longitudinal sectional view of FIG. 7A along the line D-D;

FIGS. 8A-D are longitudinal sectional views through the embodiment of FIG. 6 at increased speed;

FIG. 9 is a plan view of an intermediate mass or secondary side of an oscillatory system according to a further embodiment of a torsional vibration damping arrangement of the present invention; and

FIG. 10 is a cross sectional view through the intermediate mass of the embodiment of FIG. 9.

FIG. 11 is a partial sectional view of a torsional vibration damping arrangement incorporating the intermediate mass component of FIG. 2 in accordance with the present invention.

### DETAILED DESCRIPTION OF THE PRESENTLY PREFERRED EMBODIMENTS

It will be noted in advance that the figures are not necessarily drawn to scale and that certain components can be highlighted artificially through the use of a different line thickness or shading to emphasize certain features or characteristics.

It is explicitly noted that further embodiments are not to be limited by the specific implementations shown in the Figures. In particular, the fact that certain functionalities in the Figures are described in relation to specific entities, specific functional blocks or specific devices should not be construed to the effect that these functionalities should be, or even must be, allocated in the same manner in further embodiments. In further embodiments, certain functionalities which are associated in the following with separate components or units may be comprised in a single component or in a single functional element or can be carried out herein as functionalities which are combined in a single element or by a plurality of separate component parts.

It is further noted that when a specific element or component part is referred to as connected, coupled or linked to another element it is not necessarily meant that it is connected, coupled or linked directly to the other component part. When this is meant, it is explicitly noted by stating that the element is directly connected, directly coupled or directly linked to the further element. This means that no intermediate further element is provided which imparts an indirect coupling or connection or link. Further, identical reference numerals in the Figures denote identical components, components which function identically or components which function similarly, i.e., which are interchangeable by way of substitution between the different exemplary embodiments described in the following. Therefore, for a detailed description of a component part such as this which is shown in a Figure, reference may also be had to the description of the component part or component element in another Figure corresponding to that component part.

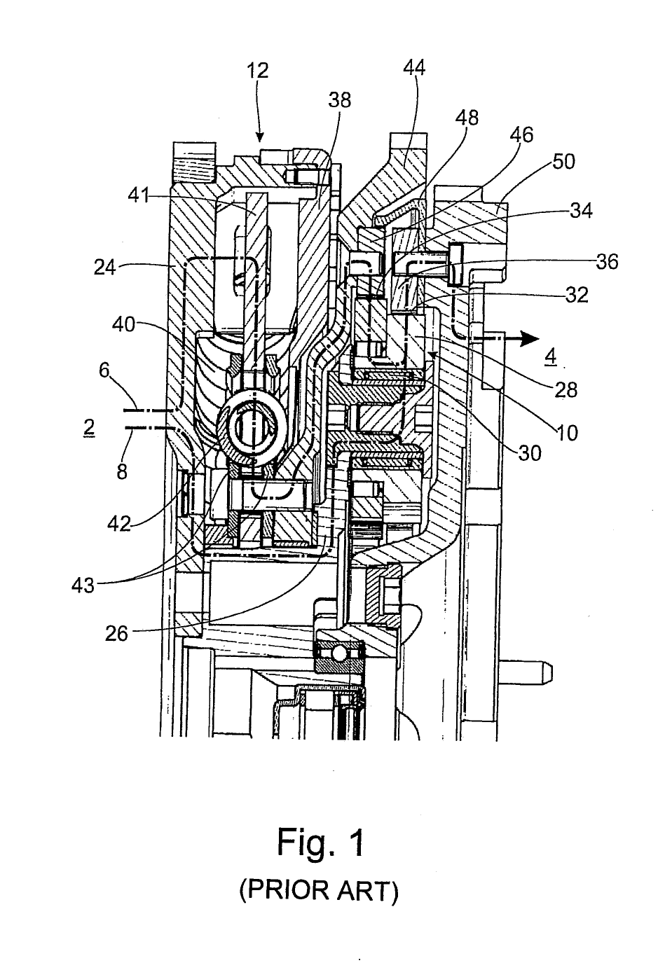

The partial-sectional view shown in FIG. 1 through a known example of a power splitting system shows a torsional vibration damping arrangement which serves to transmit a rotation from an input side 2 to an output side 4. For transmission of rotation and of the torque generated by a drive unit connected on the input side, the torsional vibration damping arrangement operates on the principle of power splitting, i.e., the torsional vibration damping arrangement has a first torque transmission path 6 and a second torque transmission path 8, wherein a first torque component can be transmitted via the first torque transmission path 6 and a second torque component is transmitted via the second torque transmission path 8 as will be described in more detail below.

The torque transmitted via the different torque transmission paths is superposed in a coupling arrangement 10, formed in the present case by an arrangement of meshing rotatable gearwheels which is based on a planetary gear set, so that the transmitted torque in its entirety can be taken off on the output side at an output-side component connected to the coupling arrangement 10.

A phase shifter arrangement 12 arranged in the first torque transmission path 6 generates a phase shift between torsional vibrations which are transmitted to the coupling arrangement 10 via the first torque transmission path 6 and torsional vibrations which are transmitted to the coupling arrangement 10 via the second torque transmission path 8. The phase shift is achieved in particular in that an oscillatory system is located in the first torque transmission path 6, and this oscillatory system forms a system via which the torque is transmitted and which has a resonant frequency below the frequency of the torsional vibrations transmitted with the torsional vibration damping arrangement at idle speed of the drive unit. This causes the exciting vibration or torsional vibration applied to the input of the oscillatory system to be shifted in phase relative to the vibration obtained at the output of the system. In the ideal case of an undamped oscillatory system, the phase shift amounts to 180° starting from the resonant frequency.

Depending on friction, spring-to-mass ratios and speed-dependent excitation, the exciting torsional vibration at the output of the coupling arrangement can be completely compensated by the superposition of the first torque component and second torque component in the coupling arrangement with a 180-degree phase shift and an identical amplitude, so that a uniform rotation from which torsional vibrations have been completely eliminated would be obtained at the output or output side of the torsional vibration damping arrangement without rotational irregularities. This operating point is referred to as a cancellation point. By changing the intermediate mass inertia, which means a change in the spring-to-mass ratio, the cancellation point also shifts to a different speed. If the intermediate mass inertia changes continuously over the speed, the cancellation point can be repositioned to the respective engine speed.

Accordingly, a complete cancellation of the vibration components can be achieved over a wider range of speeds. An undamped oscillatory system cannot be realized with friction losses or other power losses occurring in real systems. Therefore, the phase shifts which can actually be realized in the oscillatory system are under 180° depending on the distance from the resonant frequency of the oscillatory system and approach the value of 180° only at high frequencies. Nevertheless, by taking into account the damping losses and damping characteristics of the oscillatory system, a constructional design of the power splitting torsional vibration damping arrangement can be carried out such that the maximum attainable compensation of rotational irregularities is achieved at a design speed, i.e., the cancellation point. This also depends particularly on the ratio in which the transmitted torques are summed in the coupling arrangement 10.

Before describing in detail the embodiments which can lead to the change in the effective mass moment of inertia of the secondary side of the oscillatory system, the operation of the torsional vibration damping arrangement of FIG. 1 will be explained briefly in the following for the sake of better comprehension.

First, the force influences or torque influences along the individual torque transmission paths 6 and 8 are shown starting with the second torque transmission path 8. The torsional vibration damping arrangement can be connected on the input side 2 to a rotating drive unit, for example, the flywheel or crankshaft of an internal combustion engine. As is shown in FIG. 1, the aforementioned connection can be carried out, for example, via a primary mass 24, i.e., a disk-shaped solid arrangement which simultaneously forms the primary side of the oscillatory system for generating the phase shift. In the embodiment shown in FIG. 1, a planet gear carrier 26 is connected, for example, by screwing, to the primary mass 24, a plurality of rotatable planet gears 28 being arranged at the planet gear carrier 26 along the circumference of the substantially rotationally symmetrical torsional vibration damping arrangement. In the present case, the planet gear 28 which is secured to the planet gear carrier 26 by means of a rolling element bearing 30 has two sets of teeth with differing outer diameters. An output-side toothing 32 has a smaller diameter than an input-side toothing 34 of the planet gear. The output-side toothing 32 of the planet gear meshingly engages with an output-side ring gear 36 which is connected to the output side. Accordingly, the transmission of rotation or torque takes place along the second torque transmission path 8 via the primary mass 24, planet gear carrier 26, planet gear 28 and via the output-side toothing 32 of the planet gear to the output-side ring gear 36.

A phase shifter arrangement 12 comprising an oscillatory system is located in the first torque transmission path 6. In other words, the first torque transmission path 6 comprises the primary mass 24 to which, in addition, a cover plate 38 is screwed in the embodiment shown in FIG. 1. The primary side of the oscillatory system comprising the primary mass 24 is connected via a two-step spring arrangement to a secondary side of the oscillatory system, which secondary side is rotatable with respect to the primary side. The primary side is connected via a plurality of coil springs 40 of a first step to a hub disk 41, these coil springs 40 being in turn connected to output-side cover plates 43 via a plurality of further coil springs 42 of a second step. The cover plates 43 are in turn connected, by screwing, to the ring gear carrier 44 and, together with the latter, form the secondary side of the oscillatory system. The input-side ring gear 46 is arranged at the ring gear carrier 44 and meshingly engages with the input-side teeth 34 of the planet gear 28. Accordingly, the first torque transmission path 6, which has the phase shifter arrangement in the present embodiment, extends along the primary mass 24, the spring arrangement with springs 40, the hub disk 41, springs 42, the output-side cover plates 43, the ring gear carrier 44 which is screwed to the latter, the input-side ring gear 46 and via planet gear 28 to the output-side ring gear 36.

Further, for purposes of sealing the lubricated planet carrier arrangement serving substantially the coupling arrangement 10 for superposing the two torque components transmitted via the first torque transmission path 6 and the second torque transmission path 8, a bent sealing plate 48 is screwed to the output-side ring gear 36 which extends from the outside to an outer diameter of the input-side ring gear 46. Further, a secondary flywheel 50 is connected to the output-side ring gear 36, which secondary flywheel 50 is supported so as to be rotatable with respect to the primary mass 24 and, for example, can form the input side for a dry clutch arranged downstream in the powertrain. It goes without saying that other assemblies and output components can be connected to the output or output side 4 in alternative embodiments. For example, the output side 4 can be connected to a wet or dry single disk clutch, a wet or dry dual disk clutch, or a wet or dry multiple disk clutch as well as directly to a transmission input shaft of a shift transmission, automatic converter or automatic shift mechanism.

As can be seen from FIG. 1, the second torque transmission path 8 is substantially rigid, i.e., apart from the inevitable elastic deformations, a relative rotation does not take place between components arranged within this torque transmission path. Therefore, the torsional vibrations and rotational irregularities transmitted via the second torque transmission path 8 are transmitted to the coupling arrangement 10 without a phase shift or phase offset and without damping.

The oscillatory system which is arranged in the first torque transmission path 6 and is constructed similar to a conventional torsional vibration damper or dual mass flywheel generates between the primary side of the oscillatory system and the secondary side thereof the phase shift that is characteristic of the phase shifter arrangement 12. This phase shift occurs particularly in normal operation whenever the resonant frequency of the oscillatory system is selected below the torsional vibration at idle speed of the drive unit. This means that the torsional vibration components which are transmitted via the first torque transmission path 6 to the coupling arrangement 10 have a maximum phase shift of 180° with respect to those components which are transmitted via the second torque transmission path 8, so that, ideally, these torsional vibration components completely compensate one another. Accordingly, the unwanted torsional vibration can ideally be completely compensated at a cancellation point.

For the detailed description of the functionality of the torsional vibration damping arrangement it will be assumed initially that no rotational irregularities occur in the rotation to be transmitted, i.e., that there are no torsional vibrations present at the input side 2. In this case, the primary mass 24, planet gear carrier 26, hub disk 41 and input-side ring gear 46 rotate at identical speeds. Therefore, the planet gears 28 are also stationary, which results in that the output-side ring gear 36 also rotates at the rotational velocity of the primary mass 24. When there is a rapid rise in rotational velocity such as occurs when there is a rotational irregularity or rotational vibration, the second torque transmission path will follow this excitation immediately without phase delay, which results in an acceleration of the planet gear carrier 26. This planet gear carrier 26 attempts to transmit the increase in torque or increase in rotational velocity to the output side 4 via the interaction of the planet gear 28 with the output-side ring gear 36 of the coupling arrangement 10 and via the output-side ring gear 36.

However, in the first torque transmission path 6, as a result of the high-frequency, fast increase in torque and speed at the primary mass 24, the coil springs 40 are compressed and the primary side rotates with respect to the secondary side, i.e., the primary mass 24 rotates with respect to the hub disk 41 and the input-side ring gear 46. This means that the input-side ring gear 46 oscillates opposite to the planet gear carrier 26 without excitation through the rotational vibration, i.e., the rotational velocity of the input-side ring gear 46 is initially less than that of the planet gear carrier 26. As a result of the difference in speed, the planet gear 28 rotates and, in so doing, carries along the output-side ring gear 36 which can therefore not follow the increasing speed of the planet gear carrier 26 which occurs with the excitation frequency of the torsional vibration.

To summarize, the torsional vibrations are at least partially destructively superposed at the location where the two torques of the first torque transmission path 6 and second torque transmission path 8 are combined, namely, at the meshing engagement of the planet gears 28 with the ring gears 36 and 46.

In the system described thus far, a complete cancellation at only one speed would be possible in theory. The embodiments of the invention described in the following allow a virtually complete cancellation within an entire speed band.

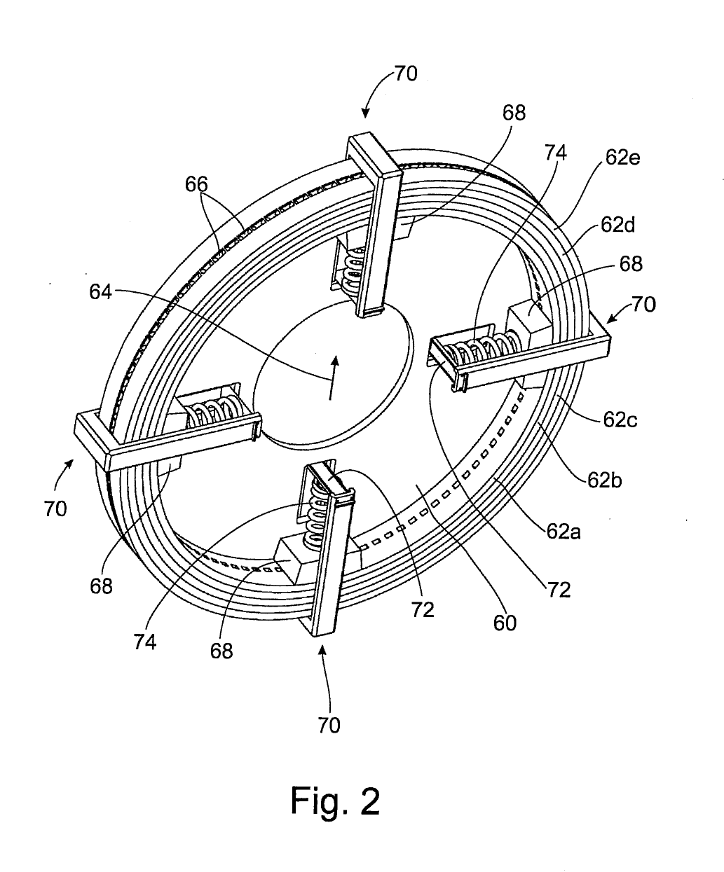

FIG. 2 and ii show an example of how the secondary side of the oscillatory system of FIG. 1 can be constructed or supplemented in order to generate a change in the effective mass moment of inertia of the secondary side dependent upon the rotational velocity. The oscillatory system in FIG. 1 is formed in particular from the primary mass 24 forming the primary side, the coil springs 40 of an outer spring set, the hub disk 41 connecting the outer spring set to an inner spring set 42, the output-side cover plates 43 and the ring gear carrier 44 which is connected to the latter so as to be fixed with respect to rotation relative to it. The ring gear carrier 44 and the output-side cover plate connected to the latter form the secondary side of the oscillatory system. As will be discussed in the following referring to FIGS. 2 to 5, the effective mass moment of inertia of the secondary side can be varied in a speed-dependent manner in that, for example, the component shown in FIG. 2 is used as ring gear carrier 44.

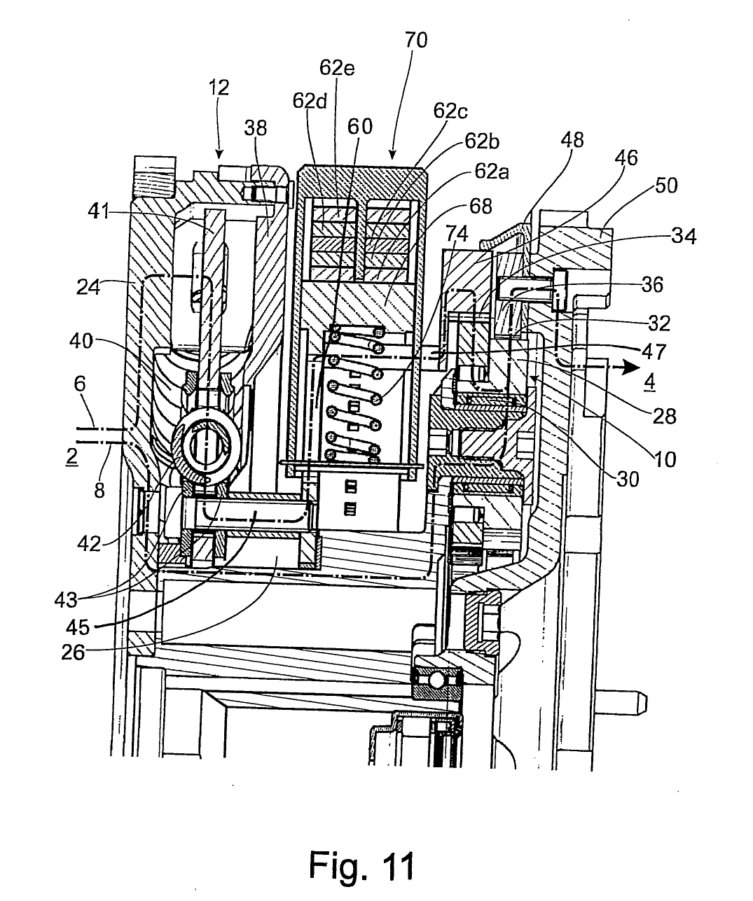

Thus, as shown in FIG. 11, the torque transmission path 6 is the same as that described in connection with FIG. 1, except that the output-side cover plates 43 are connected, e.g. with connection element 45, to central element 60 of component 100. Input-side ring gear 46 is connected, e.g. with connection element 47, to central element 60 and meshingly engages with the input-side teeth 34 of the planet gear 28.

The second torque transmission path 8 is the same as that described in connection with FIG. 1

The component 100 comprises a central element 60, which in the present case has the shape of a disk, and a plurality of, in this case five, concentric mass rings 62a-62e which are supported so as to be rotatable relative to the central element 60. In the present case, the mass elements 62a-62e are constructed in the form of mass rings which are directly adjacent to one another and are rotatable relative to one another in circumferential direction. The mass rings 62a-62e are rotatable relative to one another and relative to the central element 60 and have in each instance a plurality of apertures 66 which are adjacent to one another in circumferential direction and extend in radial direction 64 completely through the respective mass element. The inner mass ring or inner mass element 62a is rotatably mounted on a bearing block 68.

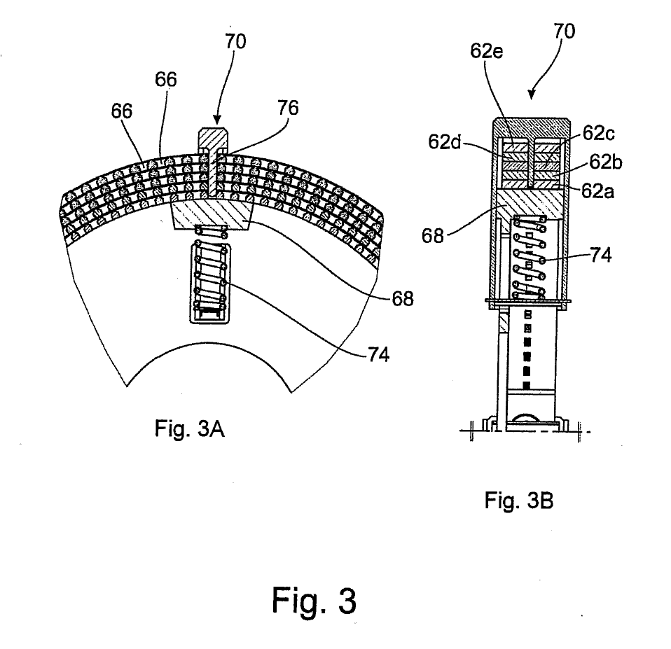

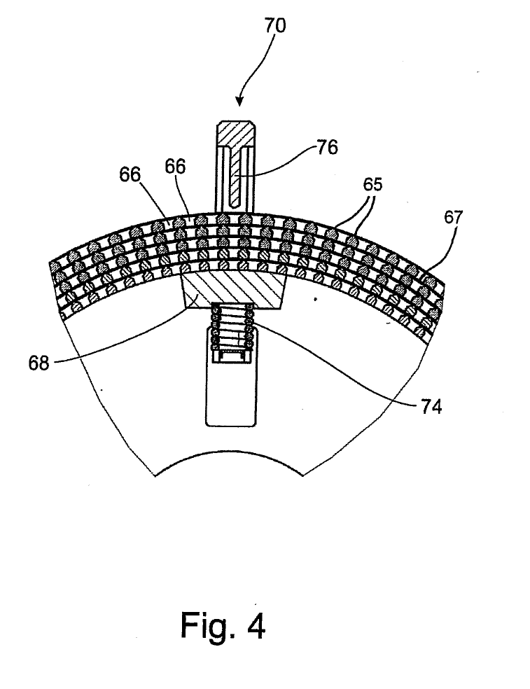

In the embodiment shown in the plan view in FIG. 2, four actuating elements 70 are distributed equidistantly along the circumference of the mass elements 62a-62e. In the embodiment shown in FIG. 2, the connection of the input-side ring gear 46 can be carried out, for example, via the bearing blocks 68 or directly via the central element 60 as shown in FIG. 11. The actuating elements 70 themselves are radially movably supported with respect to the bearing blocks 68 and, accordingly, also with respect to the central element 60 in that they have a nose or a spring which runs in a groove in the bearing blocks 68. FIGS. 3 and 4 will be referred to in the following for a better comprehension of the functioning of the embodiment in FIG. 2. FIGS. 3 A and B shows a longitudinal section and a cross section through the arrangement of FIG. 2, and FIG. 4 shows the longitudinal section of FIG. 3, but at a high rotational velocity at which the actuating element 70 is in its radially outer end position.

A spring element 74 or a spring which holds the actuating element 70 in its radially inner end position shown in FIGS. 2 and 3A and B when the arrangement is stationary is arranged between the bearing blocks 68 and a bar 72 which limits the actuating element radially inwardly. During assembly, for example, the bar 72 can be inserted through two slots in the actuating element 70 after mounting the spring 74 and then fixed by bending its ends with respect to the actuating element 70. Of course, the bar 72 can also be secured in any other manner, for example, by soldering, gluing, welding, screwing or riveting. To this end, the bar 72 can, of course, also be formed integrally from the bottom or from the radially inner side without providing openings or slots, or can be formed by shaping the radially extending side parts of the actuating element 70. The spring 74 can also be inserted only after the bar 72 is connected.

Due to the centrifugal force occurring in operation and the radially movable bearing support of the central element 60 and mass elements 62a-62e, the actuating element 70 can move radially outward against the action of the spring arrangement 74 at higher speeds because of the centrifugal force acting upon it. As will be clear from the sectional views in FIGS. 3A, B and 4, the actuating element 70 further has a locking pin 76 which extends radially inward through an aperture 66 of each mass element 62a-62e, respectively, in the radially inner position of the actuating element 70 shown in FIGS. 2 and 3A, B and accordingly connects the mass elements 62a-62e to the central element 60 so as to be fixed with respect to rotation relative to it. When the actuating element 70 moves radially outward under centrifugal force, the locking pin 76 releases the mass rings 62a-62e one after the other, i.e., at a predetermined rotational velocity associated with it, it cancels the non-rotational connection between the respective mass ring and central element 60. When the speed drops again, the actuating element 70 is moved radially inward again by the spring element 74 so that the locking pin 76 engages successively in the apertures 66 of the mass elements and connects the latter to the central element 60 non-rotationally again from outside in.

For purposes of illustration, FIG. 4 shows the actuating element 70 in its radially outer position in which the locking pin 76 is completely removed from the apertures 66 of all of the mass elements 62a-62e so that they are now freely rotatable with respect to the central element 60 and therefore no longer contribute to the effective mass moment of inertia of the arrangement shown in FIG. 2 or secondary side of the oscillatory system of FIG. 1. To facilitate a reinsertion of the locking pin 76 into the apertures 66 when the rotational velocity decreases again, the apertures 66 or mass elements 62a-62e and the locking pin 76 have lead-in chamfers 65 corresponding to one another.

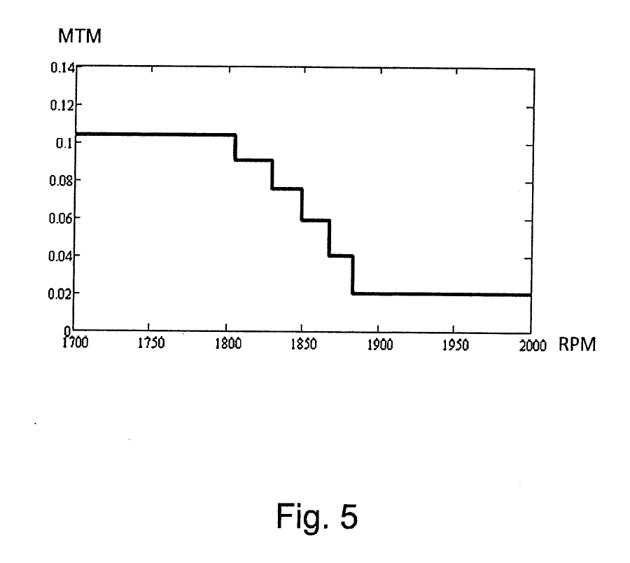

The embodiment of the invention discussed referring to FIGS. 2 to 4, makes it possible to reduce the effective mass inertia or the mass inertia with increasing speed as is shown schematically in FIG. 5 for the above-mentioned embodiment. FIG. 5 shows the rotational speed of the powertrain on the x-axis and the effective mass moment of inertia of the secondary side or total mass inertia of the intermediate mass of the power split on the y-axis of FIG. 1 in arbitrary units. In order to reduce the effective mass inertia at increasing speed, the individual mass elements 62a-62e are successively uncoupled from the central element 60 during an increase in speed as can be seen from FIGS. 3A, B and 4 and can then rotate freely on the bearing blocks 68 and relative to one another. The exact switching behavior and the speeds relevant for the cancellation of the non-rotational connection of the individual mass elements are given by the interplay between the mass of the actuating element 70, the position of the center of mass thereof and the spring stiffness or characteristic curve of the spring element 74. From this, in particular, the radial position of the actuating element 70 and therefore also of the locking pin 76 at a determined speed is given by the equilibrium of forces between the centrifugal force acting on the actuating element 70 and the spring force of the spring element 74.

A mass ring or mass element can be regarded as switched off as soon as the locking pin 76 has moved out of the respective opening or aperture 66 in the mass element, particularly the portion with the parallel flanks. The lead-in chamfers 65 serve to facilitate reinsertion at decreasing speed. When the oscillation amplitudes of the individual mass elements are greater than the solid angle area covered by an individual aperture 66, a mass ring is deemed as not yet uncoupled if the locking pin 76 is still in the region of the lead-in chamfers. In other words, in this region the non-rotational connection between mass element and central element 60 is deemed as not yet canceled. The compressed condition of spring 74 shown in FIG. 4 in which spring 74 is compressed to the maximum extent can be used, for example, as an end stop defining the radially outer position of the actuating element 70. Alternatively, of course, a mechanical end stop can also be provided in the region of the guide or in another region of the actuating element 70. In this case, the switching behavior or time at which individual mass elements are uncoupled can also be individually adapted to requirements particularly through the characteristic curve of the spring element 74.

In the adjustments of the embodiment of FIG. 2 which are shown particularly in FIG. 5, the effective mass moment of inertia changes quasi-continuously over five steps from 0.1 to 0.02, i.e., by a factor of five, in the speed range between 1800 and 1900 rpm. Of course, it is possible to adapt the change in the effective mass moment of inertia to any other applications by varying the respective parameters, particularly the characteristic curve of the spring element 74 and the individual masses of the individual mass elements 62a-62e. In particular, for example, progressive characteristic curves for the spring element 74 or discontinuous spring characteristic curves which can arise through successive switching of a plurality of springs can be used to generate a progressive behavior. The jumps of the individual steps can also be accommodated to circumstances in any way through the choice of different sizes of mass elements to be connected or mass elements with widely different inert masses.

For example, the adaptation shown particularly in FIG. 5 in which a quasi-continuous stepwise reduction in the effective total mass inertia from about 0.1 kg×m2 to 0.02 kg×m2 is achieved in a speed range between 1810 rpm and 1880 rpm can easily be expanded, for example, to the range between 1000 rpm and 2000 rpm with respect to speed or can be shifted into this range. Through suitable variation of the parameters described above, the effective mass moment of inertia can be adapted to any power split depending on what is optimal for the precise desired case of application. Of course, a degressive characteristic curve or a degressive course of the effective mass moment of inertia can also be achieved.

Although a plurality of mass elements 62a-62e or mass rings is used in all of the embodiments cited herein, it is possible in alternative embodiments to use only one mass element or mass ring which is uncoupled or connected, respectively, at a determined speed so that a discontinuity occurs in the curve of the effective mass inertia. This construction can realize a repositioning of the mass moment of inertia in an extremely economical manner.

To improve decoupling between the individual mass elements, i.e., to improve a sliding between the mass elements 62a-62e and bearing blocks 68 and between the mass elements 62a-62e themselves, friction-reducing elements of a different material with suitable friction coefficients, e.g., PTFE plates, can be incorporated, or the entire apparatus can be operated with lubrication, i.e., can run in oil or grease, for example, as schematically indicated at 67 in FIG. 4.

In alternative embodiments, the material of the mass elements 62a-62e themselves can also be suitably selected so that this material exhibits a self-lubricating effect such that when an individual mass element is uncoupled, this mass element is virtually completely decoupled from the generated effective mass moment of inertia.

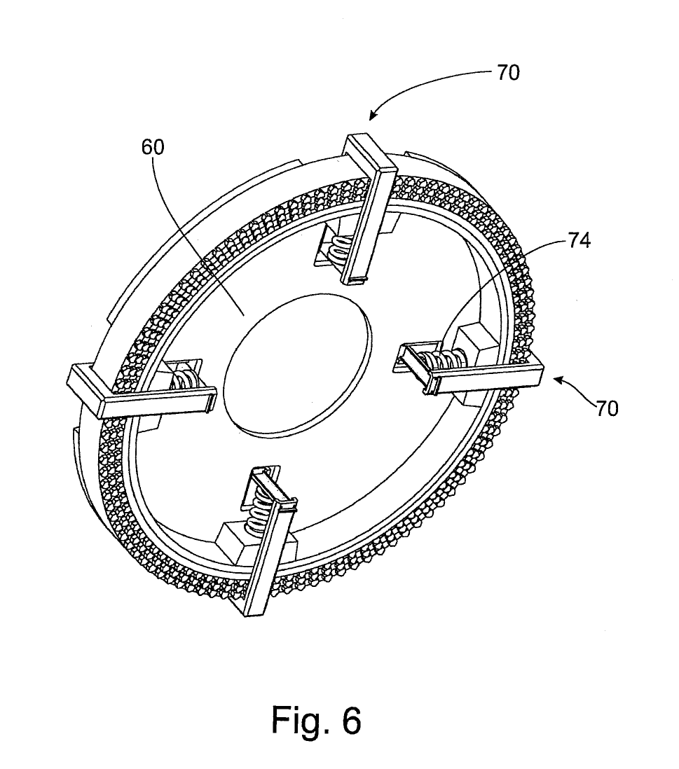

FIGS. 6 to 8 illustrate an alternative embodiment of the present invention which is essentially based on the functioning already described referring to FIG. 2.

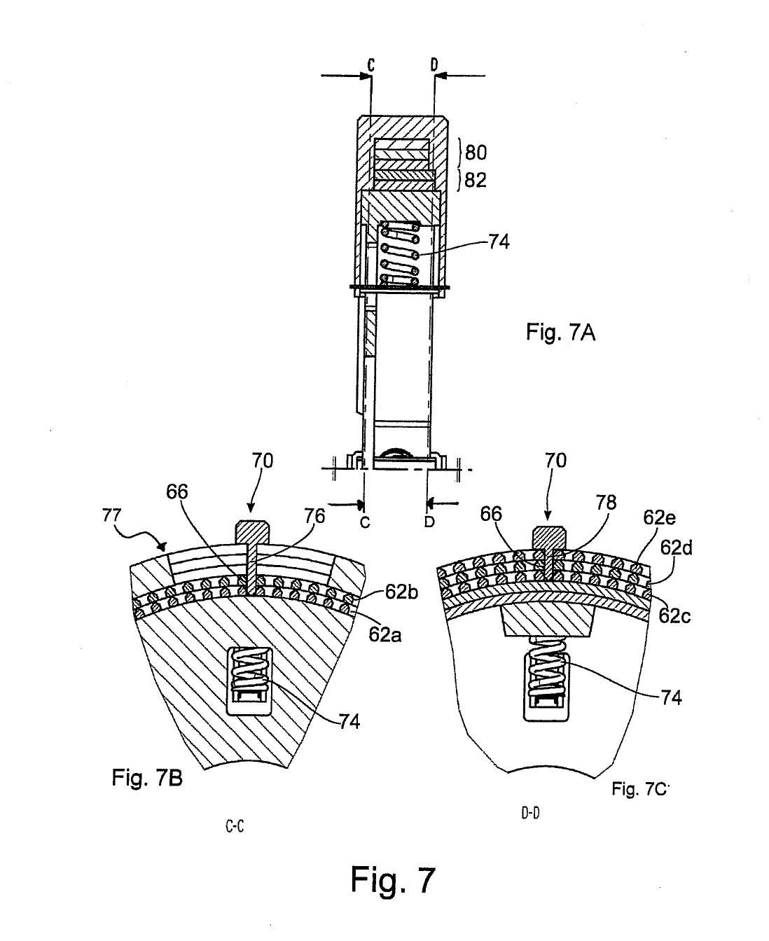

As can be seen particularly from the sectional view in FIGS. 7A-C and 8, the actuating element 70 according to this alternative embodiment has a further locking pin 78 which, in the radially inner position of the actuating element 70 illustrated in FIG. 7C, extends only though the apertures of a group 80 of radially outer mass elements 62c-e, wherein locking pin 76 FIG. 7B extends radially inward through the apertures 66 of the radially inner mass elements 62a, b. So as not to strike the locking pin 76 during a rotation, the radially outer mass elements 80 additionally have a recess 77 extending in circumferential direction in the region of the locking pin 76.

The alternative embodiment shown in FIGS. 6 to 8 make it possible to switch the same quantity of mass elements as in the embodiments in FIGS. 2 to 4 with a shorter radial travel or a smaller radial movement of the actuating element 70. Although the locking pins 76 and 78 of the actuating element 70 are arranged on the left-hand side and right-hand side in the embodiment shown in this instance, it will be appreciated that the locking pins can be arranged in any manner in alternative embodiments to achieve the same effect. The allocation can also be varied in any way. While locking pin 76 engages in the inner two mass elements 62a, b and further locking pin 78 engages in the outer three mass elements 62c-e in the embodiment under discussion, the quantity of mass elements as well as the allocation of the engagement of the different locking pins can differ in alternative embodiments. Of course, more than two locking pins can also be used in alternative embodiments so that the system can be adapted more precisely.

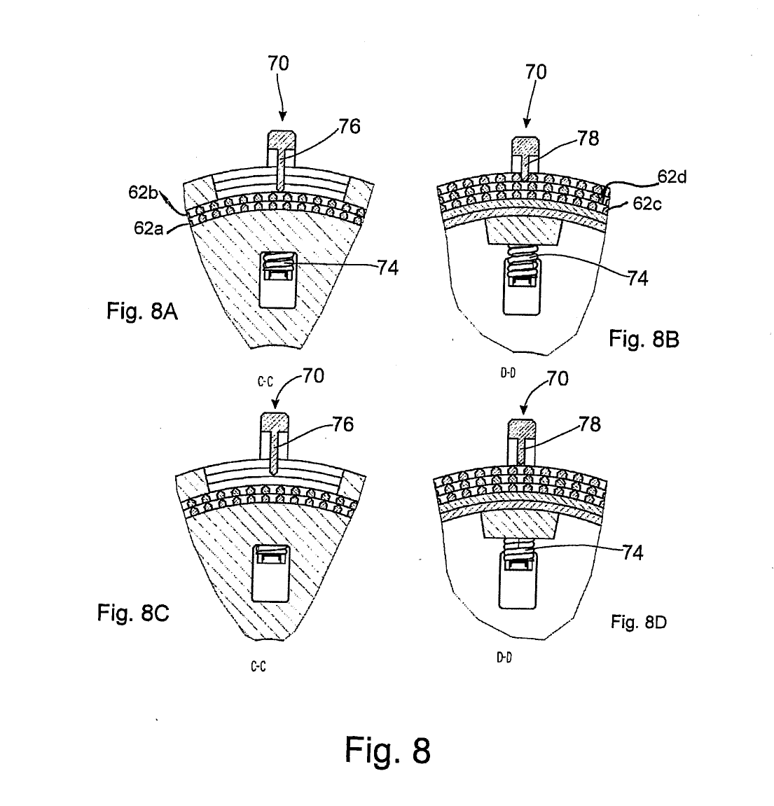

For illustrating functionality once again, FIG. 8A-D shows the position of the actuating element 70 at medium speed in FIGS. 8A and B and the position of the actuating element 70 at high speed in FIG. 8C, wherein the actuating element 70 is located at the radially outer end position. A switching characteristic similar to that in the embodiment shown in FIGS. 2 to 4 can be generated with the implementation shown in FIGS. 6 to 8, but with the difference that the locking pin is divided and is located at the axial ends of the actuating element 70. Accordingly, there is a left-side locking pin 76 and a right-side actuating slide or locking pin 78. The two actuating elements need not have the same length or engage in the same mass elements. When the actuating element moves radially outward, the mass elements 62a-62e can be released simultaneously or in quick succession, for example, depending on the desired switching behavior. Accordingly, it is possible in this case to release more mass rings or mass elements with the same movement path so that the necessary radial installation space is reduced. FIG. 8 shows two exemplary switching states. In FIGS. 8A and B, mass elements 62a-62d are released in a middle position of the actuating element 70, and in FIGS. 8C and D all of the mass elements are released. Accordingly, in the embodiments based on modifications of the actuating elements 70 shown in FIGS. 6 to 8, there are further possibilities for influencing the switching behavior.

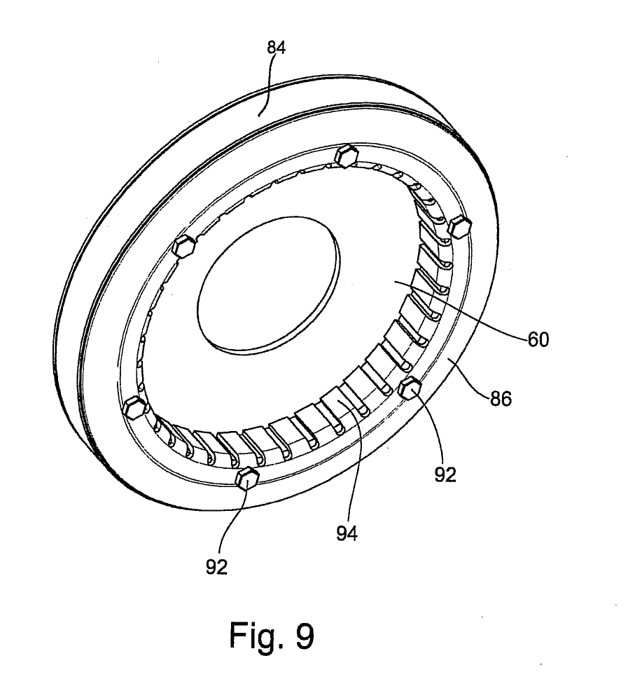

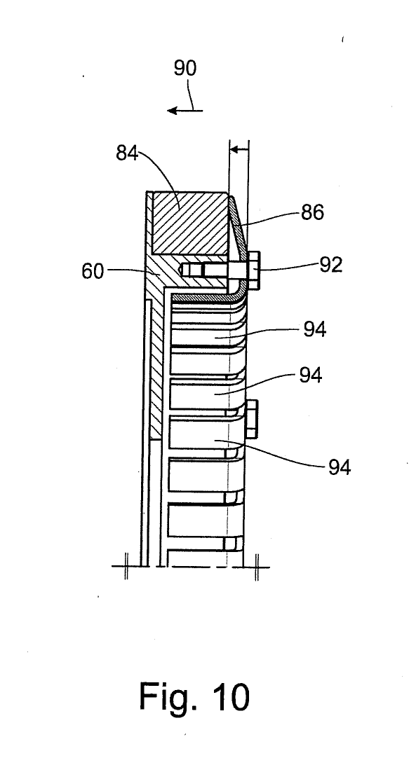

FIGS. 9 and 10 show a further embodiment in a plan view and in section, in which a mass element 84 which is movable in circumferential direction relative to the central element 60 is pressed by a spring arrangement 86 in an axial direction 90 against a thrust surface at the central element 60 so that the connection between the mass element 84 and the central element 60 is generated by friction. To this end, in the embodiment shown in FIG. 10, the spring arrangement 86 is pressed against the mass ring 84 by a spacer bolt 92. In particular, the spring arrangement 86 in this case is constructed in the form of a diaphragm spring, although any other types of spring arrangements can be used in alternative embodiments.

The diaphragm spring 86 is connected to the central element 60 via standoffs 92. The inner region of the diaphragm spring 86 is bent in direction of the mass element 84 in the form of a plurality of tongues 94. Although this bending is effected radially inside the mass element 84 in the embodiment shown in FIGS. 9 and 10, it is also possible in alternative embodiments to bend the diaphragm spring 86 radially outwardly in axial direction 90. In the embodiment shown in FIG. 9, the speed-dependent variation of the effective mass moment of inertia is achieved in that the action of the mass 84 is limited and in that the proportion of the inert mass 84 in the effective mass moment of inertia is limited. The mass ring 84 is connected to the central element 60 by the frictional engagement. If this apparatus undergoes an angular acceleration in the form of an excited rotational irregularity, the mass element 84 acts so as to directly increase the effective mass moment of inertia only up to the maximum friction value. At high angular accelerations in which the mass element 84 slides relative to the central element 60, the mass 84 no longer acts entirely to form the effective mass moment of inertia.

In other words, at high angular accelerations, the reaction force or effective mass moment of inertia is lower than in a rigid coupling. At lower angular accelerations, the mass acts to the full extent. In addition, with increasing speed, the tongues 94 are accelerated and drawn radially outward and accordingly introduce a torque into the diaphragm spring 86, which leads to reduced pressing force of the spring 86 and, accordingly, to a reduction in the maximum possible friction force. Accordingly, a speed adaptivity of the effective mass moment of inertia is achieved in addition, since the possible reaction force is limited also at lower angular accelerations and a higher speed, i.e., the effective mass moment of inertia is reduced along with the speed. The effect on the characteristic curve discussed referring to FIG. 5 with reference to the embodiment in FIG. 2 is similar so that the cancellation point of the power splitting in FIG. 1 can be expanded over a wide speed range in an equivalent manner given a suitable adaptation of the materials and friction coefficients between mass element 84 and central element 60 and of the spring stiffness of the spring arrangement 86.

While the embodiment described above refer to a dry clutch as output element, it will be appreciated that alternative embodiment can also be operated with wet or dry single disk clutch, a wet or dry multiple disk clutch, or a wet or dry dual disk clutch, and, of course, a transmission input shaft or a torque converter can also be connected directly on the output side.

In the embodiment of an oscillatory system discussed above having an outer damper with radially outer springs and an inner damper with radially inner springs, any combinations of springs of the outer damper and of the inner damper can be used additionally to realize a progressive or stepped spring characteristic. Of course, constructions with only one damper (without inner damper or without outer damper) are also possible. In every case, any combination of series connection of the utilized springs or spring assemblies can be used to achieve the desired spring characteristic.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-13. (canceled)

14. Torsional vibration damping arrangement for transmitting a rotation from an input side to an output side, comprising:
a first torque transmission path (6) arranged between the input side (2) and the output side (4) for transmitting a first torque component;
a second torque transmission path (8) arranged between the input side (2) and the output side (4) for transmitting a second torque component;
a coupling arrangement (10) constructed for superposition of the first torque component and second torque component;
a phase shifter arrangement (12) constructed for generating a phase shift between torsional vibrations which are transmitted to the coupling arrangement (10) via the first torque transmission path (6) and the torsional vibrations which are transmitted to the coupling arrangement (10) via the second torque transmission path (8), wherein the phase shifter arrangement (12) comprises an oscillatory system with a primary side coupled with the input side (2) and a secondary side which is rotatable with respect to the primary side around an axis of rotation and which is connected to the coupling arrangement (10), wherein a rotation of the primary side relative to the secondary side takes place against the action of an energy accumulator which is arranged between the primary side and the secondary side; said secondary side of said oscillatory system having an effective mass moment of inertia inhibiting a change in a rotational velocity of the secondary side, said mass movement of inertia of the secondary side being dependent upon the rotational velocity.

15. The torsional vibration damping arrangement according to claim 14, wherein the effective mass moment of inertia of the secondary side decreases as the rotational velocity increases.

16. The torsional vibration damping arrangement according to claim 14, wherein the secondary side comprises a central element (60) and at least one mass element (62a-e) non-rotationally connected to the central element (60); the non-rotational connection of the at least one mass element (62a-e) to the central element (60) constructed so as to be canceled when a predetermined rotational velocity is exceeded.

17. The torsional vibration damping arrangement according to claim 16, wherein the at least one mass element (62a-e) comprises an annular element which is movable in a circumferential direction relative to the central element (60).

18. The torsional vibration damping arrangement according to claim 17, wherein the at least one mass element (62a-e) has a plurality of apertures (66) which are adjacent to one another in circumferential direction and which extend radially through the mass element (62a-e), and additionally comprising an actuating element (70) which is movable radially from a radially inner position to a radially outer position under centrifugal force and is non-rotationally connected to the central element (60), and wherein the actuating element (70) has a locking pin (76) which extends through one of the apertures (66) of the mass element (62a-e) in a radially inner position of the actuating element (70) for non-rotational connection of the mass element (62a-e) to the central element (60).

19. The torsional vibration damping arrangement according to claim 18, wherein the secondary side has a plurality of annular mass elements (62a-e) with apertures extending radially through the mass elements (62a-e), wherein the plurality of mass elements (62a-e) are arranged concentric to one another and so as to be rotatable relative to one another in a circumferential direction, and wherein the locking pin (76) extends through an aperture in each of the mass elements (62a-e) in the radially inner position of the actuating element (70) so as to connect all of the mass elements (62a-e) non-rotationally to the central element (60).

20. The torsional vibration damping arrangement according to claim 19, additionally comprising a sliding element formed of a material differing from a material of the mass elements (62a-e) arranged between radially adjacent mass elements (62a-e) in order to reduce a friction between the adjacent mass elements (62a-e).

21. The torsional vibration damping arrangement according to claim 18, additionally comprising a spring element (74) and wherein the actuating element (70) is movable radially outward under centrifugal force against the action of the spring element (74), and wherein the spring element (74) has one of a progressive spring characteristic curve and a spring characteristic curve having at least one abrupt change in spring stiffness.

22. The torsional vibration damping arrangement according to claim 19, wherein the actuating element (70) comprises at least one further locking pin which extends only through the apertures (66) of a group (80) of radially outer mass elements (62c-e) in the radially inner position of the actuating element (70), and wherein the mass elements (62c-e) of the group (80) of radially outer mass elements have a recess extending in circumferential direction in the further region of the locking pin (76).

23. The torsional vibration damping arrangement according to claim 16, wherein the mass elements (62a-e) are arranged within a volume which is at least partially filled with a lubricant.

24. The torsional vibration damping arrangement according to claim 14, additionally comprising a spring arrangement (86); and wherein the secondary side comprises a central element (60) and at least one mass element (84) which is movable in circumferential direction relative to the central element (60); the mass element (84) being pressed by the spring arrangement (86) in an axial direction (90) against a thrust surface at the central element (60) to achieve a frictionally induced connection to the central element (60).

25. The torsional vibration damping arrangement according to claim 24, wherein a pressing force caused by the spring arrangement (86) is dependent on the rotational velocity.

26. The torsional vibration damping arrangement according to claim 14, in which the coupling arrangement (10) comprises a planetary gear set arrangement including an input-side ring gear (46), and planet gears (28); and wherein the input-side ring gear (46) which meshingly engages with the planet gears (28) of the planetary gear set arrangement is non-rotationally connected to the secondary side.

27. The torsional vibration damping arrangement according to claim 15, wherein the secondary side comprises a central element (60) and at least one mass element (62a-e) non-rotationally connected to the contral element (60); the non-rotational connection of the at least one mass element (62a-e) to the central element (60) constructed so as to be canceled when a predetermined rotational velocity is exceeded.

28. The torsional vibration damping arrangement according to claim 19, additionally comprising a spring element (74) and wherein the actuating element (70) is movable radially outward under centrifugal force against the action of the spring element (74), and wherein the spring element (74) has one of a progressive spring characteristic curve and a spring characteristic curve having at least one abrupt change in spring stiffness.

29. The torsional vibration damping arrangement according to claim 20, additionally comprising a spring element (74) and wherein the actuating element (70) is movable radially outward under centrifugal force against the action of the spring element (74), and wherein the spring element (74) has one of a progressive spring characteristic curve and a spring characteristic curve having at least one abrupt change in spring stiffness.

30. The torsional vibration damping arrangement according to claim 20, wherein the actuating element (70) comprises at least one further locking pin which extends only through the apertures (66) of a group (80) of radially outer mass elements (62c-e) in the radially inner position of the actuating element (70), and wherein the mass elements (62c-e) of the group (80) of radially outer mass elements have a recess extending in circumferential direction in the region of the further locking pin (76).

31. The torsional vibration damping arrangement according to claim 21, wherein the actuating element (70) comprises at least one further locking pin which extends only through the apertures (66) of a group (80) of radially outer mass elements (62c-e) in the radially inner position of the actuating element (70), and wherein the mass elements (62c-e) of the group (80) of radially outer mass elements have a recess extending in circumferential direction in the region of the further locking pin (76).

32. The torsional vibration damping arrangement according to claim 15, additionally comprising a spring arrangement (86); and wherein the secondary side comprises a central element (60) and at least one mass element (84) which is movable in circumferential direction relative to the central element (60); the mass element (84) being pressed by the spring arrangement (86) in an axial direction (90) against a thrust surface at the central element (60) to achieve a frictionally induced connection to the central element (60).
